(19) United States
(12) Patent Application Publication
(10) Pub. No.: US 2008/0262961 A1
(43) Pub. Date: Oct. 23, 2008

(54) Merchant Credit Risk Monitoring

(75) Inventors: Todd A. Dellomo, Ronkonkoma, NY (US); Brian K. Gallagher, Hartsdale, NY (US); Craig Mitchell, Westhampton, NY (US); Edward Wang, Syosset, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/736,445

(22) Filed: Apr. 17, 2007

(51) Int. Cl. G06Q 40/00

(52) U.S. Cl. 705/38

(57) ABSTRACT

A method of managing risk associated with processing merchant credit card transactions includes establishing a plurality of merchant processing relationships with a plurality of merchants, compiling transaction history for each of the plurality of merchants, identifying a business relationship between at least two of the plurality of merchants, based on the business relationship, associating the at least two merchants into a single processing relationship, and periodically calculating a measure of processing risk for the single processing relationship by, at least in part, combining the transaction history compiled for each of the at least two merchants. In some embodiments the method includes, based on the measure of processing risk, changing a periodic review schedule for the processing relationship.

### CROSS-REFERENCES TO RELATED APPLICATIONS

This application is related to the following co-pending, commonly assigned U.S. patent applications: application Ser. No. 10/108,781, filed Mar. 27, 2002, and entitled “Decision Tree Systems And Methods,” application Ser. No. 10/109,198, filed Mar. 27, 2002, and entitled “Merchant Application And Underwriting Systems And Methods,” application Ser. No. 10/108,934, filed Mar. 27, 2002, and entitled “Merchant Activation Tracking Systems And Methods,” application Ser. No. 10/108,575, filed Mar. 27, 2002, and entitled “Systems And Methods For Monitoring Credit Risk,” application Ser. No. 11/241,765, filed Sep. 29, 2005, and entitled “Presentation Instrument Transaction Processing Pricing Systems And Methods,” and application Ser. No. 11/337,086, filed Jan. 19, 2006, and entitled “Merchant Credit Issuance And Monitoring Systems And Methods,” the entirety of each of which are herein incorporated by reference for all purposes.

### FIELD OF THE INVENTION

Embodiments of the invention relate generally to the field of financial transaction processing. More specifically, embodiments of the invention relate to methods for monitoring risk associated with extending credit to merchants.

### BACKGROUND OF THE INVENTION

Financial transactions involving the use of presentation instruments, such as credit cards, play an important role in today's economy. A typical credit card transaction proceeds by extracting account information from the credit card, typically using a point of sale device at a merchant location, and submitting the account information along with a requested payment amount to a processing system. Such a processing system may involve the merchant's bank, a credit card association and associated processing network, such as the VISA) network or the MASTERCARD® network, and/or the issuer's bank, as is known in the art.

Hence, in order to process a credit card transaction, a merchant typically establishes an account with a processing organization, one example of which is FIRST DATA® of Englewood, Colo. Because the processing organization takes on certain financial risks when agreeing to process a merchant's transactions, an application and underwriting process typically takes place before an account is opened. For example, an account may be established by first requiring the merchant to fill out a credit application. The credit application is then sent to an underwriter who reviews information in the application to determine whether the merchant would be a suitable client. If so, the account is established, and the merchant may begin accepting at least certain types of credit cards as payment for their goods or services.

Over time, however, the risk associated with processing the merchant's transactions may change. This may result from changes in the merchant's business line, changes in the types of products the merchant sells, changes in the volume of transactions the merchant processes, the timeframes in which the services are rendered or products are delivered, and/or the like.

In some cases, however, risk associated with a merchant is related to other merchants. For example, a chain of merchants may be codependent; they could all go out of business at the same time. Similarly, merchants who are outlets of a common entity may be dependent on the common entity for their ongoing operation and a failure of the common entity could be the end of operations for all outlets. Methods are needed to accurately evaluate and monitor the credit and/or fraud risks.

Conversely, some entities may be evaluated too conservatively for risk purposes. For example, a franchisor may have a number of franchisees that are not dependent on one another or the franchisor for continuing operations; a failure of the franchisor or any particular franchisee would not affect the continuation of a different franchisee. Hence, methods are needed that allow credit risk associated with such merchants to be evaluated independently.

### BRIEF SUMMARY OF THE INVENTION

Embodiments of the invention provide a method of managing risk associated with processing merchant credit card transactions. The method includes establishing a plurality of merchant processing relationships with a plurality of merchants, compiling transaction history for each of the plurality of merchants, identifying a business relationship between at least two of the plurality of merchants, based on the business relationship, associating the at least two merchants into a single processing relationship, and periodically calculating a measure of processing risk for the single processing relationship by, at least in part, combining the transaction history compiled for each of the at least two merchants. In some embodiments the method includes, based on the measure of processing risk, changing a periodic review schedule for the processing relationship. The method may include segmenting a plurality of entities comprised by one of the plurality of merchants into a plurality of distinct processing relationships. The method also may include, based on the measure of processing risk, determining approval review requirements relating to a periodic review of the processing relationship. The method may include, in response to an approval review of the periodic review of the processing relationship, collecting additional data relating to the merchants comprised by the processing relationship and storing the additional data for further review. Compiling transaction history for each of the plurality of merchants may include converting selected items from the transaction history into a common currency. The method may include, based on the measure of processing credit risk, changing a reserve of funds relating to the processing relationship.

Other embodiments provide a computer-implemented method of managing merchant credit card processing risk. The method includes creating data records in a periodic review system for each of a plurality of merchants, compiling transaction history at a processing platform for each of the plurality of merchants, wherein the transaction history comprises data relating to each merchant's credit card transaction receipts, collecting business date relating to each of the plurality of merchants, storing the business data in the periodic review system, periodically transmitting the transaction history from the processing platform to the periodic review system, periodically querying the periodic review system from a user terminal, wherein a specific query returns to the user terminal a report comprising information from the data records, transaction history, and business data for at least two merchants, determining that the at least two merchants have a business relationship, from the user terminal, providing a command to the periodic review system that relates the at least two merchants into a single processing relationship, from the user terminal requesting from the periodic review system a report comprising a calculated measure of processing risk for the processing relationship, and based on the calculated measure of processing risk, adjusting a reserve of funds for the merchants comprised by the processing relationship. The method may include, based on the calculated measure of processing risk, changing a periodic review schedule for the processing relationship. The method may include, based on the business data for a specific merchant, identifying a plurality of processing entities comprised by the specific merchant and establishing distinct processing relationships for each of the plurality of processing entities. The method may include, based on the calculated measure of processing risk, determining approval review requirements relating to a periodic review of the processing relationship. The method may include, in response to an approval review of the periodic review of the processing relationship, collecting additional data relating to the merchants comprised by the processing relationship and storing the additional data for further review. Periodically transmitting the transaction history from the processing platform to the periodic review system may include converting selected items from the transaction history into a common currency.

Still other embodiments provide a method of periodically reviewing risk associated with merchant credit card processing accounts. The method includes establishing merchant credit card processing accounts for each of a plurality of merchants, storing business data relating to each of the plurality of merchants in the merchant credit card processing accounts, processing credit card summary transactions for each of the plurality of merchants, compiling transaction summary history based on the credit card transactions for each of the plurality of merchants, providing a periodic review system configured to periodically receive the transaction history for each of the plurality of merchants, using the periodic review system, requesting a report comprising at least a portion of the business data and at least a portion of the transaction history for at least one merchant, based on the report, identifying a plurality of processing entities comprised by the merchant, establishing distinct processing relationships for each of the plurality of processing entities, calculating a measure of processing risk associated with a particular one of the processing relationships, and, based on the calculation, making a change in a reserve of funds associated with the processing relationship. The method may include, based on the calculation, changing a periodic review schedule for the particular one of the processing relationships. The method may include, based on the report, combining the at least one merchant into a single processing relationship with at least one other merchant. The method may include, based on the measure of processing risk, determining approval review requirements relating to a periodic review of the processing relationship. Compiling transaction history based on the credit card transactions for each of the plurality of merchants may include converting selected items from the transaction history into a common currency. The method may include, in response to an approval review of the periodic review of the processing relationship, collecting additional data relating to the merchants comprised by the processing relationship and storing the additional data for further review.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary system in which embodiments of the invention may be practiced.

FIGS. 2A and 2B illustrate exemplary methods according to embodiments of the invention, which methods may be implemented in the system of FIG. 1.

FIGS. 3A and 3B depict first and second portions, respectively, of an account record search screen according to embodiments of the invention.

FIGS. 4A and 4B depict first and second portions, respectively, of an account summary screen according to embodiments of the invention.

FIGS. 5A and 5B depict first and second portions, respectively, of a review schedule screen according to embodiments of the invention.

FIGS. 6A and 6B depict first and second portions, respectively, of a risk assumption screen according to embodiments of the invention.

FIG. 7 depicts an account review status screen according to embodiments of the invention.

### DETAILED DESCRIPTION OF THE INVENTION

Embodiments of the present invention relate to credit risk monitoring. In order to provide a context for describing embodiments of the present invention, embodiments of the invention will be described herein with reference to monitoring credit risk associated with merchants who are creditors of a credit card issuer or credit card processor by virtue of a credit card transaction settlement process and/or the associated processing rules. Those skilled in the art will appreciate, however, that other embodiments are possible. For example, embodiments of the invention may be used to monitor credit risk associated with traditional lender/borrower relationships.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Credit card transaction processing services are known, one example of which is the service provided by FIRST DATA® of Englewood, Colo. When a business entity (hereinafter “merchant”) desires to accept credit cards or other presentation instruments as payment for goods or services, it typically engages the services of a credit card processor (hereinafter “processor” or “processing organization”) to process its transactions. Systems and methods for establishing and maintaining merchant accounts are more fully explained in previously-incorporated U.S. patent application Ser. No. 10/109,198 and U.S. patent application Ser. No. 10/108,934. Because credit processing organizations assume a certain degree of credit risk by accepting a merchant as a client, the application process includes an underwriting process wherein the credit processing organization estimates the degree of credit risk exposure.

According to embodiments of the present invention, a credit card processor employs a periodic review system (PRS) to calculate, monitor, and manage the credit risk associated with merchant credit card processing accounts. According to the exemplary methods disclosed herein, transaction history for merchant accounts and other data is periodically processed into reports that allow analysts to assess whether the processing organization is properly managing the risk for each processing relationship.

As used herein, a processing relationship is a merchant or collection of merchants that present monetary credit risk to the processing organization by virtue of the processing organization processing credit card transactions for the merchant or merchants. A processing relationship may include more than one merchant if, for example, the merchants have some dependence on one another (e.g., related as a chain, outlets of a common entity, etc.).

Risk to a processing organization may result from several factors, including, for example, failure to issue a refund on returned merchandise, charge backs, and non-delivery of services or products. Credit risk may result, for example, from a merchant's failure or inability to process return(s), fund chargeback(s), and/or render services or deliver products. If a merchant receives an item returned from a customer but fails to process the return transaction, the customer does not receive the credit due. The processing organization may be forced to credit the customer's account and attempt to collect from the merchant when the cardholder charges back their transaction through their issuing bank.

The method by which a merchant obtains a customer's account number may introduce charge back risk. In-person sales using a point of sale device generally introduce less risk than other transaction methods. This is so for a variety of reasons, including, for example: the merchant is able to verify certain information about the customer presenting the credit card as payment; the transaction is posted immediately; and the customer acknowledges the transaction by signing a receipt. On the other hand, mail order and telephone order transactions (i.e., “card not present” transactions), wherein account information is given over the phone or through the mail, eliminate many of the safeguards inherent to in-person transactions. This is also the case with Internet sales. If a merchant does not physically swipe a customer's card, there is a higher likelihood that the customer may deny the transaction (i.e., “charge back” the transaction). The processing organization then must attempt to collect from the merchant. The higher the volume of card not present transactions processed by a merchant, the greater the credit and/or fraud risk to the processing organization.

Non-delivery risk results when a cardholder does not receive the benefit of the transaction for some period of time after the merchant receives credit (payment) for the transaction. Travel purchases are such an example. If the merchant goes out of business after having received credit (payment) but before the service or merchandise is delivered to the cardholder, the cardholder may contact their issuing bank and chargeback the transaction. When the merchant is unable or unwilling to fund the chargeback, the processing organization becomes a creditor of the merchant.

Processing organizations use various formulas to properly quantify merchant risk, examples of which are more fully described in previously-incorporated U.S. patent application Ser. No. 11/241,765. Some processors utilize a merchant's SIC code, or Standardized Industrial Classification code, to compare merchants with other merchants according in their same industry. Because merchants within a particular industry tend to have similar percentages of mail order and telephone order sales and similar delivery times and patterns, the risk associated with merchants in a particular industry tends to be similar. Thus, credit processing organizations use industry-specific criteria in the credit underwriting process by assigning a SIC code to each merchant But in the case of outlets, chains, franchises, and the like, processing organizations may be over- or underestimating merchant risk. According to the methods described herein, however, processing organizations are able to properly quantify the risk.

Once a merchant is accepted as a client and the merchant begins accepting credit cards and other presentation instruments for payment, the processing organization places a point-of-sale device at the merchant's business location(s) or otherwise provides the merchant the ability to transfer transaction details to the processor. The details minimally include the customer's account identifier and the amount of the transaction (a.k.a., “ticket amount”). The processor credits a portion of the transaction amount (a.k.a., “settlement amount”) to the merchant's bank account and initiates the process of obtaining funds from the customer. The processor typically withholds a portion of the transaction amount as compensation for processing the transaction either on a daily, weekly or monthly basis. The amount withheld may be a percentage of the transaction amount, a flat fee, a percentage of a total volume processed for the merchant, or the like. The withheld amount is considered the “discount risk.”

In some cases, the processor requires a “reserve” for a merchant. The reserve is a sum of money otherwise due the merchant that the processor maintains to mitigate the credit and fraud risk associated with a particular merchant. Because certain factors associated with a merchant may change over time (volume of processed transactions, change backs, non-delivery days, etc.), it is important for a processor to monitor the credit and fraud risk and adjust the reserve accordingly, at least for the processor's larger accounts. It is also important to properly define the processing relationship so that the credit and fraud risk is properly evaluated. Embodiments of the present invention provide the ability to very accurately monitor credit risk.

According to embodiments of the invention, a processor employs investigators to collect information about a merchant and analysts to review merchants according to a review schedule. The review schedule may be adjusted, as will be described herein. Prior to the scheduled review, the investigator begins collecting necessary review information. This may include pulling consumer and commercial credit bureau reports, interviewing the merchant, reviewing trade/supplier references, contacting the merchant's lending and/or depositor bank, and/or the like. The investigator stores all the information in the PRS.

Meanwhile, the merchant is processing transactions, and the transaction information is being compiled in a central repository. The PRS receives the information from the repository and performs various automated analyses. This may include totaling the merchant's processed volume, charge back volume, refund activity, non-delivery days, and calculating the risk associated with the merchant according to a formula used by the processing organization. Advantageously, the PRS may collect transaction history from a number of different processing platforms, and in a variety of currencies. The transaction history may be converted into a common history to thereby aid the review.

Once the information has been collected and the scheduled review time arrives, the analyst begins the review. The analyst uses the PRS to conduct the review. The review provides the analyst with the merchant's transaction history, current calculated risk, peak risk, and other useful information. The analyst has available all of the information collected by the investigator. The analyst reviews the merchant's processing relationship to better determine if the appropriate processing relationship has been setup in PRS for the review. If, for example, the analyst determines that the merchant is really an outlet of a larger entity, then the merchant may be added to the larger entity so that risk is properly evaluated. As another example, if the analyst determines that the merchant should be treated more appropriately as a franchise, then the analyst can extract the merchant from a larger entity for independent risk evaluation. Many other possibilities exist.

In conducting the review, the analyst may determine that the processor is maintaining too large or too small of a reserve for the merchant. The analyst may make or recommend the changes in the reserves when using PRS.

Based on the review, the analyst may determine that the merchant's review schedule should be changed. The PRS may suggest the schedule based on a number of factors. In either case, the analyst uses the PRS to make the proper schedule adjustments.

As a result of the review, it may be determined that the review requires certain levels of approval. The level of approval may be determined by any of a number of factors, such as, for example, the merchant's risk, the merchant's sales volume or any factor in the merchant's transaction history, the analyst's discretion, and the like. The PRS determines the level of approval based upon the CA values assigned to the accounts as well as the rating assigned to the merchant accounts. Reviewers may provide comments and action items to analysts and investigators who then must follow up before a review can be considered complete.

The PRS also is used to monitor the entire review production process. For example, reports are available that show which reviews are due, past due, in process, completed, in approval, and the like.

Conveniently, the PRS information may be available via a network to thereby allow access from a variety of locations. For example, analysts and investigators may be located a different work sites nationally or internationally, either may telecommute, and reviewers in the approval chain need not be co-located with either the analysts or investigators. Moreover, the PRS maintains a complete history of the review process for future reference.

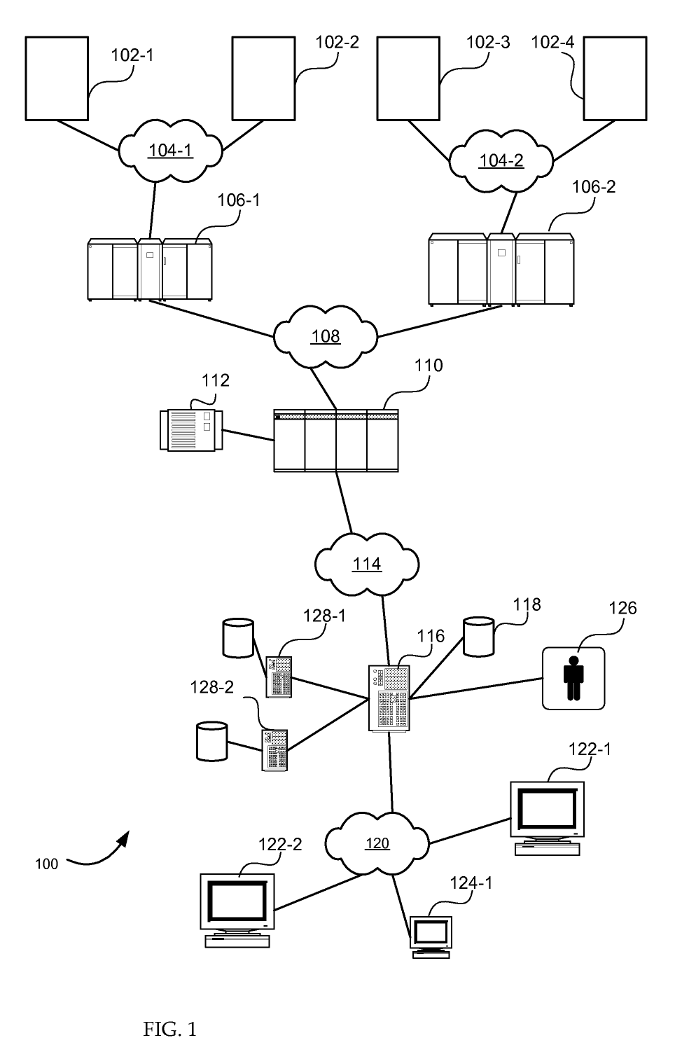

Having described embodiments of the present invention generally, attention is directed to FIG. 1, which illustrates an exemplary system 100 in which embodiments of the invention may be implemented. Those skilled in the art will appreciate that the system 100 is merely exemplary of a number of possible systems in which the present invention may be embodied. The system 100 includes a number of merchants having point of sale (POS) devices 102 which post transactions via networks 104 to processing platforms 106. The transactions are processed as is known in the art.

Periodically, the processing platforms 106 provide transaction history via a network 108 to a central repository 110 where the transaction history is stored on a storage system 112. The transaction history is then available via a network 114 to a periodic review system (PRS) 116.

The PRS 116 may be a single computer and associated software, a distributed computing system, a mainframe, or any of a variety of other computing systems known to those skilled in the art. The PRS has a data storage system 118 associated therewith. The PRS 116 is configured to communicate via a network 120 with user computers, which may be, for example, analyst computers 122, reviewer computers 124, and/or the like. The PRS 116 may be configured to act as a web server to deliver information to user computers via a web browser.

The network 120 may be any suitable network, including the Internet. The user computers 122, 124 may be any suitable computing device.

As will be explained in greater detail hereinafter, the PRS 116 periodically receives transaction information from the central depository 110. The PRS uses this information to calculate risk for individual merchants and processing relationships. It also summarizes the transaction history for merchants, including sales volume, charge backs, returns, average non-delivery days, and the like. The PRS is also configured to receive information from investigators 126, who provide information necessary for merchant reviews. The PRS may be in communication with other internal and external system 128 to receive information such as credit reports, risk management information (e.g., reserves), and the like. The PRS compiles the information into reports useful to analysts and the processing organization. The PRS includes code that programs it to perform various steps in the exemplary method embodiments of the present invention.

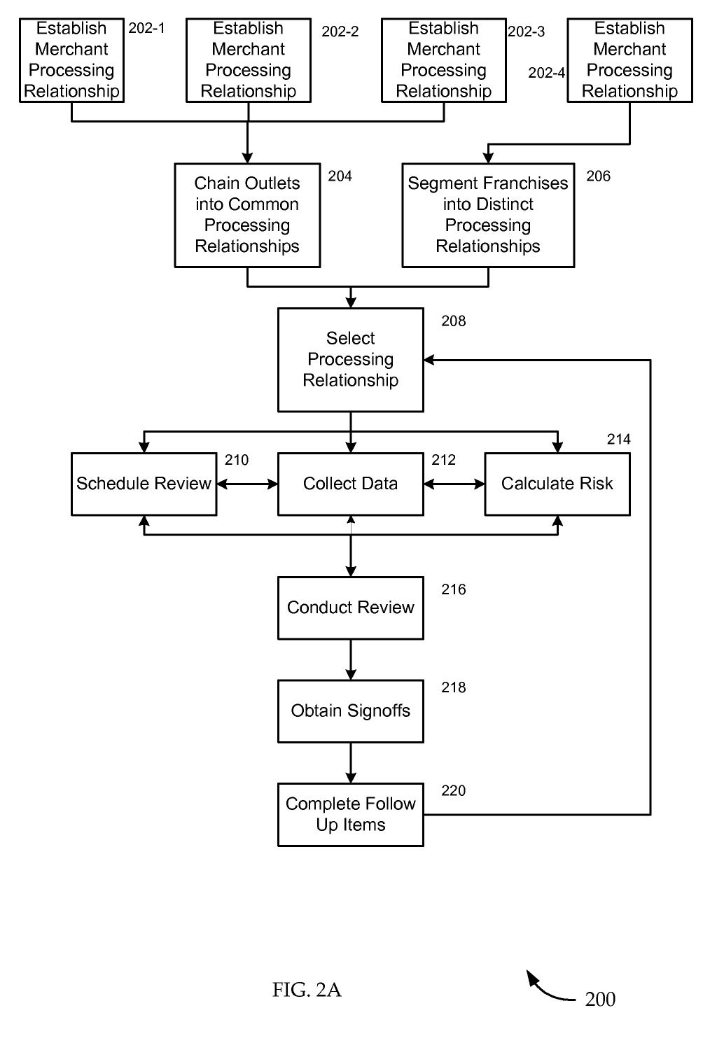

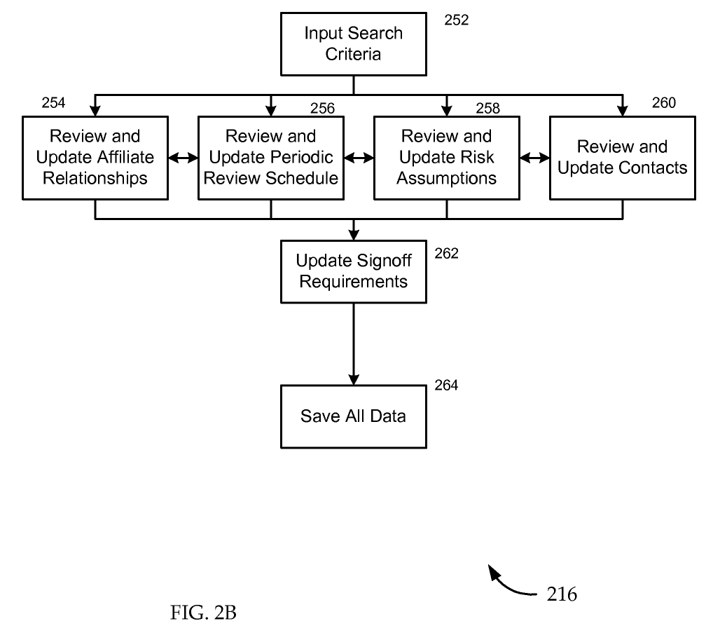

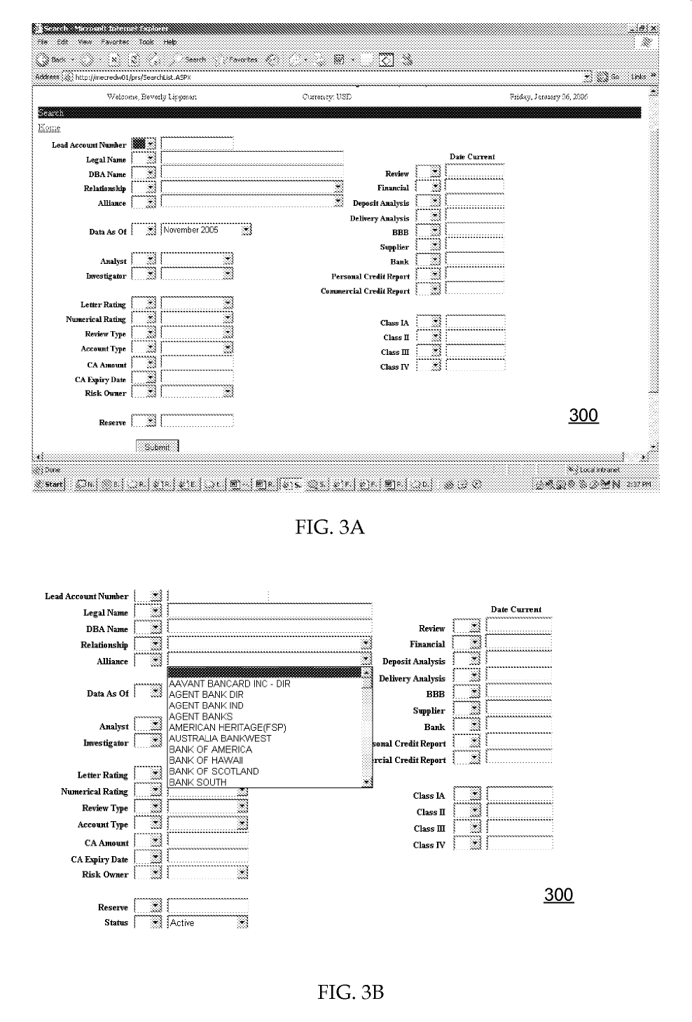

Having described a system in which embodiments of the resent invention may be implemented, attention is directed to FIGS. 2A and 2B which depict exemplary methods according to embodiments of the present invention. The methods will be described with reference to the screens depicted in FIGS. 3 through 7. Those skilled in the art will appreciate that the methods pictured and described herein are merely exemplary of a number of possible embodiments that may include more, fewer, or different steps than those illustrated and described herein. Moreover, other exemplary method embodiments may include the same or similar steps as those illustrated and described herein, but may traverse those steps in different orders.

FIG. 2A depicts an exemplary merchant review method 200 according to embodiments of the invention. The method begins at one of blocks 202 at which point a processing organization establishes a processing relationship with a merchant. Systems and methods for establishing a merchant processing relationship are described more fully in previously-incorporated U.S. patent application Ser. No. 10/109,198. At block 204, it may be determined that two or more merchants should be related together in a processing relationship. This may be because the merchants are related as outlets, chains, or the like, which are best evaluated as a single processing relationship. At block 206, merchants that are, for example franchises, may be segmented apart from one another into distinct processing relationships. The operations of blocks 204 and 206 allow a processing organization to properly quantify merchant risk and set reserves and transaction prices accordingly. These steps may take place as part of the initial establishment of the merchant processing relationship or as part of a periodic review process as will be described hereinafter.

Once a merchant processing relationship is established for a merchant, the merchant may begin using the processor to process its credit card and other presentation instrument transactions. Periodically, the processor desires to evaluate it merchants to ensure that the processor is properly managing the processing credit risk posed by the merchant. The periodic reviews may be conducted on individual merchants or groups of merchants related together into a processing relationship. Hence, the ensuing description discusses the periodic review process in the context of a “processing relationship” review, even though the processing relationship may include only one merchant. Similarly, where “merchant” is used in the ensuing description, it should be understood that the merchant is a processing relationship or is part of one.

Beginning at block 208, the PRS performs, and/or facilitates the performance of, certain operations for a particular processing relationship. It should be understood that the ensuing steps could be performed simultaneously for a number of processing relationships and the steps for a particular processing relationship could be performed concurrently or consecutively. For example, periodic reviews may be scheduled at block 210, data may be collected at bock 212, and/or risk may be calculated at block 214 concurrently or consecutively and for many processing relationships at once.

Scheduling a review, as indicated by block 210, for a processing relationship may take place at initial account setup and/or as part of a periodic review process. Scheduling the review may be based on any or all of a number of factors, including, for example, the risk presented by a processing relationship. Generally, the more risk presented by a merchant, the more frequent the merchant should be reviewed. As another example, if a merchant's risk is fluctuating abnormally, it might be desirable to review the merchant more frequently. Many other examples exist.

At block 212, review data is/are collected. Review data may include commercial credit bureau reports, personal credit bureau reports, merchant interviews, transaction history (sales, credits, chargebacks, etc.), and/or the like. The data are stored in the PRS for later use by a periodic review analyst.

At block 214, risk is calculated. As mentioned previously, risk calculation may take many forms. In a specific embodiment, risk is a dollar value that is based, at least in part, on the merchant's sales, chargebacks, returns, non-delivery days, SIC code, and the like.

At block 216, the actual periodic review is conducted using the PRS described above. The periodic review process of block 216 will be described more fully with respect to FIG. 2B.

Once a periodic review is complete, review approvals, or signoffs, are performed at block 218. Depending on a number of factors, different levels of signoffs may be required. Reviewers are able to access the electronically stored information completed by an analyst are either signoff, make comments, require follow-up items, and the like.

At block 220, an analyst or investigator completes any required follow-up items. All information is stored for future review, and the process loops back to block 208 where the process begins for a different processing relationship. Of course, as mentioned previously, may such reviews may be in progress simultaneously.

Attention is now directed to FIG. 2B in combination with FIGS. 3A through 7 for a more detailed discussion of the periodic review process 216 from the perspective of an analyst using the PRS. As indicated, the periodic review process 216 depicted in FIG. 2B is an expansion of block 216 of FIG. 2A. The process begins at block 252, at which location an analyst using the PRS inputs search criteria to select one or more processing relationships for review. It should be appreciated that prior to accessing this point in the process, the analyst may have logged on to the system, or otherwise complied with various security requirements limiting access to the PRS or the information contained therein.

FIGS. 3A and 3B depict top and bottom views, respectively, of a display screen 300 that may be used to enter search criteria used to select merchants for review. For example, using the data fields of the display screen 300, merchants may be selected by Legal Name, DBA Name, and/or Lead Account Number. Conveniently, drop-down menus may be used to generate lists from which an analyst may choose search criteria. For example, a drop-down list is depicted for selecting merchants based on an Alliance, which, if used as a search criteria, would return all merchants that are part of the selected alliance.

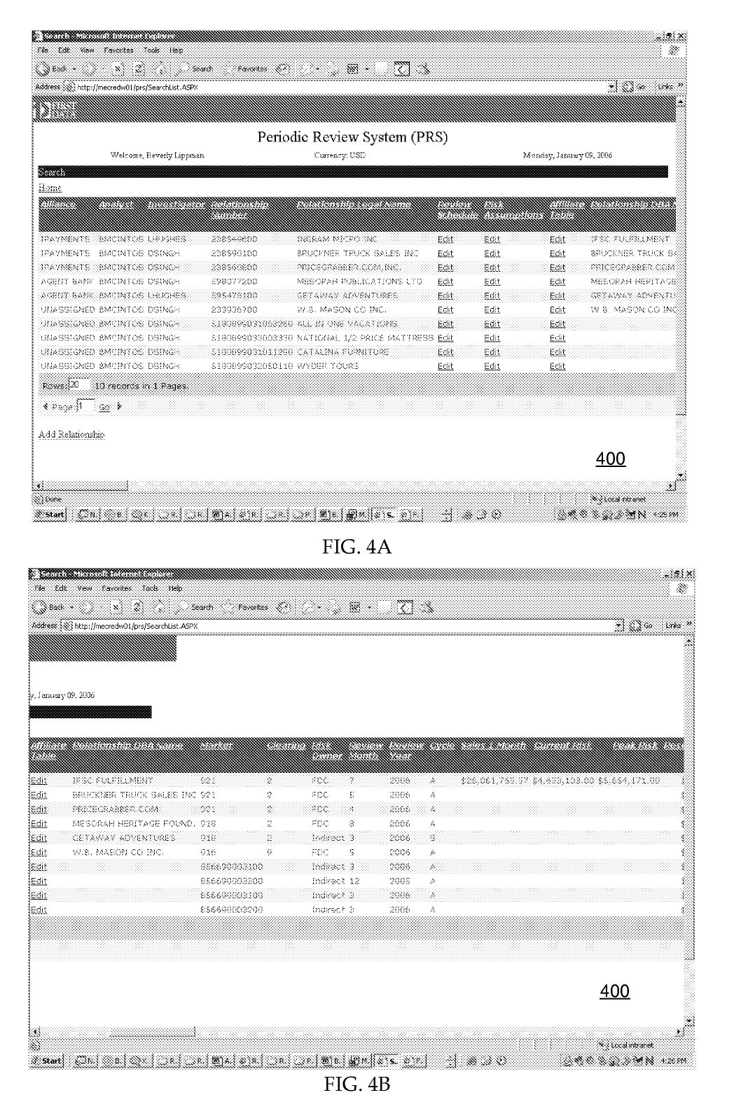

Once the search criteria are entered, the PRS returns a listing of merchants matching the criteria. FIGS. 4A and 4B depict left and right views, respectively, of a display screen 400 which lists several merchants (i.e., “Relationships”) and summary-level information about each. As indicated by the headings, the information includes: an Alliance to which the relationship may belong; an Analyst who may be responsible for performing periodic reviews of the relationship; an Investigator who may be responsible for gathering data relating to the relationship; a Relationship Number that identifies the Relationship; The Relationship Legal Name; the Relationship DBA Name; etc. The display screen 400 also includes hyperlinks for editing a Relationship's Review Schedule, Risk Assumptions, and Affiliate Table.

Returning to the periodic review process 216 of FIG. 2B, once an analyst has selected a group of relationships for review, the analyst may: review and update affiliate relationships at block 254, review and update the periodic review schedule at block 256, review and update risk assumptions at block 258, and/or review and update contacts at block 260. As indicated, the analyst may perform any or all of these functions and may move between them several times before completing the review.

In reviewing and updating affiliate relationships at block 254, the analyst may rely, for example, on information gather by an investigator to determine that a merchant should be associated with one or more other merchants into a single processing relationship. The merchants may be related, for example, as outlets, members of a chain, etc. Thereafter, the risk of a particular merchant may be analyzed and managed within the context of the larger alliance of which it is a part. Likewise, processing relationships that include a number of merchants who should be more appropriately treated as individual processing relationships in light of their business operation (e.g., a franchises) may be segmented into individual processing relationships at this point.

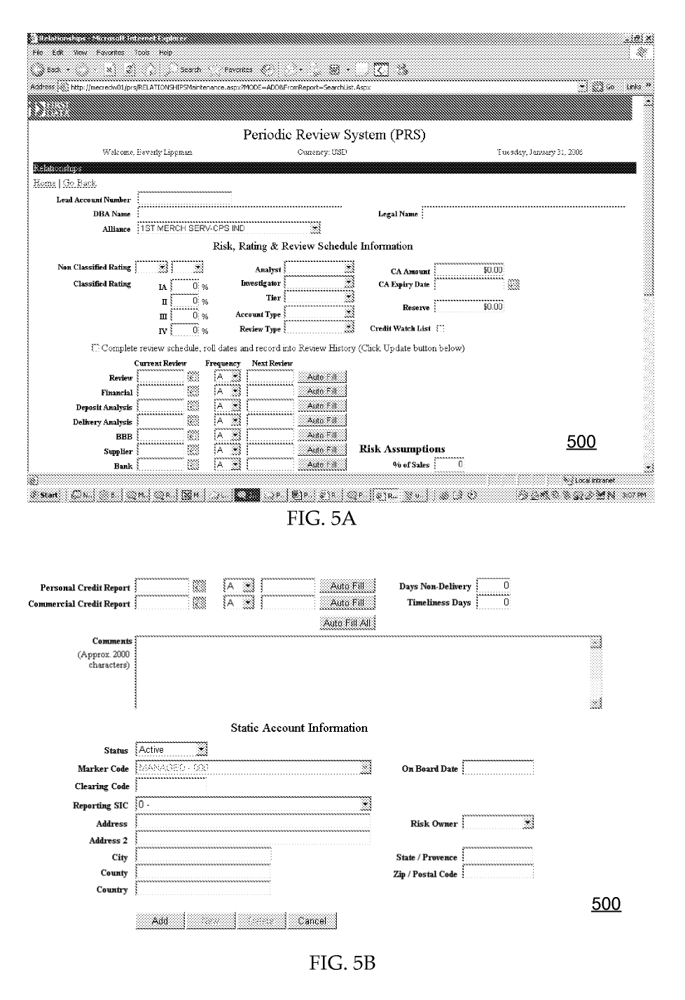

At block 256, an analyst may update a periodic review schedule for a Relationship. Conveniently, the display screen 500 of FIGS. 5A and 5B may aid this effort. The display screen 500 includes data fields into which the analyst may enter Current Review and Next Review dates. Entering the Current Review date may be sided by a calendar selection icon that populates a selected date into the field. The Next Review date my be auto-filled based on a selected review Frequency, which may be a drop-down menu from which the analyst selects, for example, annual, semi-annual, monthly, etc.

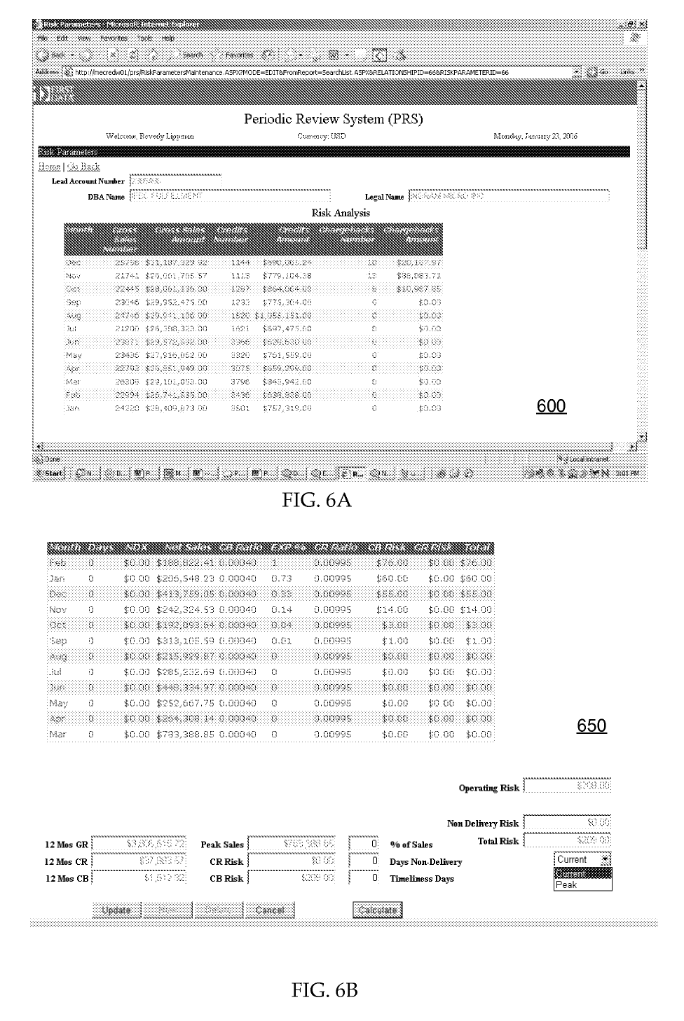

At block 258, an analyst may review and/or update a processing relationship's risk assumptions. The display screens 600, 650, depicted in FIGS. 6A and 6B may be used to do so.

The display screen 600 of FIG. 6A includes recent transaction history for a merchant covering a one year time frame. For each month of the year, the display screen lists the merchant's Gross Sales Number, Gross Sales Amount, Credits Number, Credits Amount, Chargebacks Number, and Chargebacks Amount. These figures are useful in evaluating the risk attributable to the merchant. The display screen 650 of FIG. 6B provides additional information that is also useful to the analyst to evaluate merchant risk. The information provided by the display screen 650 includes the number of non-delivery days (NDX), Net Sales, chargeback ratio (CB Ratio), exposure (EXP %), credit ratio (CR Ratio), chargeback risk (CB Risk), credit risk (CR Risk) and total risk (Total). Based on this review, however, the analyst may make risk assumption changes. Data fields are available for changing % of Sales, Days Non-Delivery, and Credit Timeliness Days.

The risk review is helpful to determine whether sufficient reserves are maintained to mitigate credit risk posed by a merchant. Based on the review, the analyst may recommend an adjustment to the reserves. In some cases, the analyst may be able to implement the change, in others, the merchant may be required to have the changed approved during the review signoff process at block 218.

At block 260, the analyst may update merchant contact information. This is useful for making subsequent reviews more efficient.

As mentioned previously, the analyst may update signoff requirements, which also may be an automated decision based on the merchant's risk. This takes place at block 262.

Conveniently, all information associated with a merchant review may be stored in the PRS for future reference. This takes place at block 264.

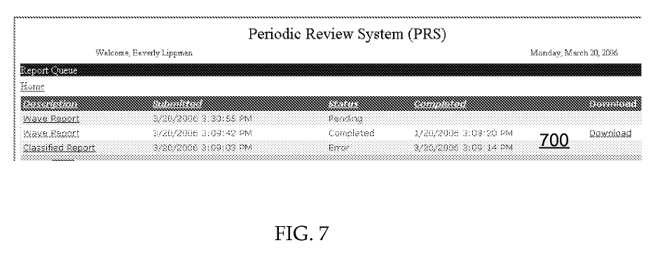

Yet another feature of the PRS is depicted in the display screen 700 of FIG. 7. The display screen 700 allows an analyst or others to track the progress of a completed review through the approval process.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Moreover, those skilled in the art will appreciate that the concepts discussed herein may be directed toward other types of risk monitoring, such as traditional borrowers and the like. Accordingly, the above description should not be taken as limiting the scope of the invention, which is defined in the following claims.

What is claimed is:

1. A method of managing risk associated with processing merchant credit card transactions, comprising:
establishing a plurality of merchant processing relationships with a plurality of merchants;
compiling transaction history for each of the plurality of merchants;
identifying a business relationship between at least two of the plurality of merchants;
based on the business relationship, associating the at least two merchants into a single processing relationship; and
periodically calculating a measure of processing risk for the single processing relationship by, at least in part, combining the transaction history compiled for each of the at least two merchants.

2. The method of claim 1, further comprising, based on the measure of processing risk, changing a periodic review schedule for the processing relationship.

3. The method of claim 1, further comprising, segmenting a plurality of entities comprised by one of the plurality of merchants into a plurality of distinct processing relationships.

4. The method of claim 1, further comprising, based on the measure of processing risk, determining approval review requirements relating to a periodic review of the processing relationship.

5. The method of claim 4, further comprising:
in response to an approval review of the periodic review of the processing relationship, collecting additional data relating to the merchants comprised by the processing relationship; and
storing the additional data for further review.

6. The method of claim 1, wherein compiling transaction history for each of the plurality of merchants comprises converting selected items from the transaction history into a common currency.

7. The method of claim 1, further comprising, based on the measure of processing credit risk, changing a reserve of funds relating to the processing relationship.

8. A computer-implemented method of managing merchant credit card processing risk, comprising:
creating data records in a periodic review system for each of a plurality of merchants;
compiling transaction history at a processing platform for each of the plurality of merchants, wherein the transaction history comprises data relating to each merchant's credit card transaction receipts;
collecting business date relating to each of the plurality of merchants;
storing the business data in the periodic review system;
periodically transmitting the transaction history from the processing platform to the periodic review system;
periodically querying the periodic review system from a user terminal, wherein a specific query returns to the user terminal a report comprising information from the data records, transaction history, and business data for at least two merchants;
determining that the at least two merchants have a business relationship;
from the user terminal, providing a command to the periodic review system that relates the at least two merchants into a single processing relationship;
from the user terminal requesting from the periodic review system a report comprising a calculated measure of processing risk for the processing relationship; and
based on the calculated measure of processing risk, adjusting a reserve of funds for the merchants comprised by the processing relationship.

9. The method of claim 8, further comprising, based on the calculated measure of processing risk, changing a periodic review schedule for the processing relationship.

10. The method of claim 8, further comprising, based on the business data for a specific merchant:
identifying a plurality of processing entities comprised by the specific merchant; and
establishing distinct processing relationships for each of the plurality of processing entities.

11. The method of claim 8, further comprising, based on the calculated measure of processing risk, determining approval review requirements relating to a periodic review of the processing relationship.

12. The method of claim 9, further comprising:
in response to an approval review of the periodic review of the processing relationship, collecting additional data relating to the merchants comprised by the processing relationship; and
storing the additional data for further review.

13. The method of claim 8, wherein periodically transmitting the transaction history from the processing platform to the periodic review system comprises converting selected items from the transaction history into a common currency.

14. A method of periodically reviewing risk associated with merchant credit card processing accounts, comprising:
establishing merchant credit card processing accounts for each of a plurality of merchants;
storing business data relating to each of the plurality of merchants in the merchant credit card processing accounts;
processing credit card summary transactions for each of the plurality of merchants;
compiling transaction summary history based on the credit card transactions for each of the plurality of merchants;
providing a periodic review system configured to periodically receive the transaction history for each of the plurality of merchants;
using the periodic review system, requesting a report comprising at least a portion of the business data and at least a portion of the transaction history for at least one merchant;
based on the report, identifying a plurality of processing entities comprised by the merchant;
establishing distinct processing relationships for each of the plurality of processing entities;
calculating a measure of processing risk associated with a particular one of the processing relationships; and
based on the calculation, making a change in a reserve of funds associated with the processing relationship.

15. The method of claim 14, further comprising, based on the calculation, changing a periodic review schedule for the particular one of the processing relationships.

16. The method of claim 14, further comprising, based on the report, combining the at least one merchant into a single processing relationship with at least one other merchant.

17. The method of claim 14, further comprising, based on the measure of processing risk, determining approval review requirements relating to a periodic review of the processing relationship.

18. The method of claim 14, wherein compiling transaction history based on the credit card transactions for each of the plurality of merchants comprises converting selected items from the transaction history into a common currency.

19. The method of claim 14, further comprising:
in response to an approval review of the periodic review of the processing relationship, collecting additional data relating to the merchants comprised by the processing relationship; and
storing the additional data for further review.
